(19) United States
(12) Patent Application Publication
(10) Pub. No.: US 2023/0339177 A1
(43) Pub. Date: Oct. 26, 2023

(54) 3D PRINTER

(71) Applicants: Martijn Arnoud KOREVAAR, Katwijk (NL); VEDA GROUP B.V., Katwijk (NL)

(72) Inventor: Martijn Arnoud KOREVAAR, Katwijk (NL)

(21) Appl. No.: 17/777,995

(22) PCT Filed: Nov. 20, 2020
(86) PCT No.: PCT/IB2020/060942

§ 371 Date: May 19, 2022

(51) Int. Cl. B29C 64/209; B29C 64/295; B33Y 30/00

(52) U.S. Cl. CPC B29C 64/209; B29C 64/295; B33Y 30/00; B29C 64/118

(57) ABSTRACT

The present invention discloses 3D printer, 3D printing based manufacturing system in which a filament of printing material is driven into a printer head, comprising a heat block provided with a filament receiving chamber into which the filament is to be driven and in which the filament, during passage through the chamber towards an end, such as a distal end of the heat block for delivery of filament material, is to be transformed into a molten, at least weakened, plastically deformable state. It comprises of one or more sections subsequently included, at least one section of the receiving chamber is provided with grooves, the grooves being included at an angle with the axis of the chamber. It also discloses a method of operating a 3D printer The heater block may favorably be thermally separated from a feeder element by means of a thermally isolating distance member passing the filament.

### FIELD AND BACKGROUND OF THE INVENTION

The present invention relates to an improvement in a so-called 3D device manufacturing system, in popular sense also known as a 3D printer, an improved print head and manner of using or operating a print head.

So called 3D printing based device manufacturing systems have been out in the art ever since 1982, however have presently not only become popular in amateur or hobbyist areas for various purposes, but have also in industry become established as a professional means of producing devices or spare parts. The economic significance of these systems not only resides in the ability to relatively easily create special shapes or to quickly create prototypes for testing purposes, but also in on demand supply, saving various forms of costs like in storage, transport and administration.

The print head of such systems very often is derived from preceding plastic molding technology, be it that the conventional melting technology thereof is often developed for receiving and melting granulate material rather then filament material. In the respect of a 3D printer departing from the use of filament material as presently at stake, CN104647751A of May 2015 discloses a heat conductive material attached on the inner side wall of the hole passing through a heating block of the print head and the center of the nozzle. In the annexed figure, plastic string 1 may be noticed, fed by extruder 9 into a heater block 3, feeding molten plastic into a nozzle 4. The plastic heating system is improved by the insertion of a “plate heater 7” in a “heating chamber” having internal copper walls and external insulating material 3. Where the application of the plastic heating system may be shaped or described differently, the underlying problem of uniformly melting plastic for a subsequent application or use thereof in molten form is a generic one of melting and is in many cases essentially not solved differently than already known from this CN publication. One example of such may e.g. be the embodiment of WO2016047732, published 31 Mar. 2016, which teaches to provide the hole with a division into a large centralized hole section and a lower section (3) with multiple holes (see FIG. 5). While the latter publication is dedicated to 3D printing, it in fact utilizes known solutions of uniformly melting plastic in a manner of a straight forward carry over of existing technology to 3D printers. Another, generic example of a 3D printer system coping with the necessity of melting a filament of material may amongst others be found in U.S. Pat. No. 9,233,506 relating to a liquefier assembly for use in additive manufacturing system. Other embodiments as known from CN105034381A, may divide a filament receiving chamber of relative large size compared to the filament cross section, in several sections separated by sieve like element, called filter, for holding back larger and by subsequent filters, smaller non molten chunks of filament.

### BRIEF SUMMARY OF THE INVENTION

In the present invention various essential improvements have been made to the known 3D printer, both in various constituent parts which have been elucidated in the description and, as will become clear may often also be applied independently from one another, in many types of 3D printer, and methods of 3D printing. All in view of promoting either or both of the speed and the quality of printing.

In particular, the invention herein claims a 3D printer, in particular for a 3D printing based manufacturing system in which a filament of printing material is driven into a printer head, so as to be expelled therefrom in molten form, the printer head comprising a heat block provided with a filament receiving chamber into which the filament is to be driven and in which the filament, during passage through the chamber towards an end, such as a distal end of the heat block for delivery of filament material, is to be transformed into a molten, at least weakened, preferably plastically deformable state, the receiving chamber comprising of one or more sections subsequently included, characterized in that at least one section of the receiving chamber is provided with grooves, the grooves being included at an angle with the axis of the chamber. With such a measure, the filament material, as weakened on the outside is mixed with, if not scraped apart from a core part of material that may not yet have been in contact with the heating chamber wall, and the printing process may remarkably be sped up, in that the passage of the filament and filament material through the print head is promoted by at least a scraping effect caused by the angle under which the grooves are included, and as is presumed, possible also by a mixing effect thereof. In a favorable embodiment the grooves are provided in a second section of the chamber as taken in the direction of filament entry towards exit of weakened filament, allowing the filament first to be heated up and weakened, at least on the outer side, thereby not only lowering resistance in feed through of the filament, but also causing the scraping of and mixing to take place at some distance from the entry-point, thereby preventing that soft material may easily creep upwards, at least to escape from junctions at entry point of the filament.

It is remarked that the receiving chamber in the invention, taken in cross section, at least largely is to correspond in dimension and shape with the cross section of the filament to be received, so as to thereby realize maximum of the desired and in accordance with the invention foreseen effect. In this respect it is also favorable that a first section of the chamber closely surrounds the filament received, typically forming a closely surrounding cylindrical section.

In further elaboration, the receiving chamber merges into a final section of the heat block, provided with multiple channels, connecting the receiving chamber with the end of the heat block. In this manner the melting or alternatively denoted weakening, in particular homogeneous weakening, and hence plastic deformability of filament material is even further optimized in that, and preferably a significant number of relatively small channels each provide an optimal surface to content or volume ratio for this purpose, thus further enhancing both capacity and quality of a printer according to this invention.

It is remarked that the preceding matter may be and is herewith reserved for independent claiming from the groove feature of this invention. Adding the grooves is more complicated and hence somewhat more expensive, however considerably increases the capacity of the printer, in that without the groove action, the capacity may become reduced to even about 40% of that with the grooves. The quality effect as described remains however, so that the channels, i.e. bores as disclosed in this invention are reserved for claiming in connection with a receiving chamber not having the grooves.

Favorably, the channels are formed by straight bores, so that manufacture is enhanced in that the bores may be favorably entered from the distal end of the heat block. In this invention, the bores in the heat block may preferably be included radially diverging. Independently of the preceding, the bores are in a plane transverse to that determined by the radial diverging, included under an angle with the axis of the receiving chamber. Preferably and economically, the throughput enhancing grooves as presented before are formed by an end section of a bore. In yet further sophistication of the printer, part of the channels is formed by bores connecting with the end of the receiving chamber, e.g. the end of a second, grooved section.

The printer of this invention may be characterized by a feature in which the bores end distributed around a central core of the heat block. In particular, the central core is of a cross section larger in size than that of a bore. In this, preferably the bore ends as taken in end view, are provided at least substantially equally distributed in a regular shape, in particular within a circular shape, concentrically positioned relative to the axis of the chamber.

The here improved printer may favorably feature a heat block provided with a nozzle, the nozzle provided with a receiving chamber for receiving material expelled by the heat block and guiding the same to a central discharge opening of the nozzle. Herein the receiving chamber of the nozzle may be provided with a generally conical shape pointing away from the heat block end.

It is remarked that a printer in accordance with this invention may feature a heat block provided with and heated by cylindrically shaped heat elements, included in parallel with the chamber axis and extending over the largest part of the axial length of the heat block. Such measure supports, if not enhances the homogeneous weakening of the filament material to be deposited. A heating element hence preferably extends over at least substantially the entire axial length of the receiving chamber. The heat block may best comprise at least three of the coaxially included heat element, regularly distributed around the receiving chamber.

The nozzle mentioned before is provided for adhering to the heater block, e.g. via connecting, i.e. screwing or gluing and end face to a corresponding end face of the heat block. It may also have a screw thread provided to the outer side, i.e. circumference of an end part of the heat block, thereby enveloping, i.e. axially overlapping with at least an end part of a heater element. In an actual embodiment, the nozzle is provided with an end face for contacting a distal end of the heat block, the heat elements of the heat block being provided to extend virtually up to the end face.

### BRIEF DESCRIPTION OF THE DRAWINGS

Various aspects of the invention and an example of part of an embodiment of the invention is illustrated in the drawings which depart from the general and wide spread knowledge of 3D printing system and extruders therefor, and in which:

FIG. 1 schematically depicts a certain cross sectional view of a print head in accordance with the present invention;

FIG. 2 is another cross sectional view of the same, further clarifying the print head design of the invention;

FIG. 3 in a cross section illustrates a further embodiment and example of a heat block part of a printer according to the invention.

FIGS. 4B to 4G illustrate various cross sections of the heater block of FIGS. 1 and 2 in subsequent locations between an entry point as illustrated by the top view of FIG. 4A and the end or bottom part of the nozzle provided heat block as illustrated by perspective view in FIG. 4H;

FIG. 5 illustrates an independently applicable invention and measure, according to which the heater block is split up into an outer section carrying electric heater elements and an inner, detachable section in which the receiving sections for the filament to be liquefied;

FIG. 5A provides an external, perspective view of the an invention according to which the filament receiving chamber of a heater block splits up into different channels for guiding and heating filament material, here embodied without any grooved chamber section, as is illustrated by FIG. 6;

FIG. 6A, in a perspective view illustrate yet an other invention, here cooperating with the invention of FIG. 5, according to which the print nozzle is screwed to an external thread of the heater block.

FIG. 6A illustrates that the present invention and/or its aspects may be applied in conjunction with other inventions and measures mentioned here such as the invention in accordance with FIG. 6, the one measure thus becoming an aspect of the other, while still also independently being applicable if so preferred or desired; is provides the view with the nozzle removed, and further illustrates a preferred embodiment in which the heater block is split up into four separate channels debouching into a normally conically shaped plenum of the here not depicted print nozzle;

FIG. 7A and 7 from an outer perspective view and from a cross sectional view illustrate the invention of providing a standing layer of air around the heater block, in particular by providing the heat sink circumferential to rather than in line with the heater block. As in FIGS. 1 and 2, FIG. 7 also illustrates the invention of providing a thermally isolating distance member between the heat sink, be it the upper wall thereof, or the lower end thereof as in prior art designs.

FIG. 8 illustrates an embodiment in which the heater block section accommodating the separate channels is designed of greater height that than the first section with central receiving chamber for the filament.

FIG. 8A illustrates the invention relating to the thermally decoupling distance member applied in an otherwise largely conventional printer head design;

FIG. 9 illustrates the application of the invention of a standing layer of air, or circumferentially applied heat sink to an otherwise largely conventionally designed heater block.

FIG. 9A illustrates the application of circumferentially distributed screws between heater block and feeder element in an otherwise conventionally designed printer head, as well as the measure of having in this case four electric heater elements protruding from the heater block;

FIGS. 10 and 10A illustrate different perspective views of the design according to FIG. 9.

### DESCRIPTION OF ILLUSTRATIVE EMBODIMENTS

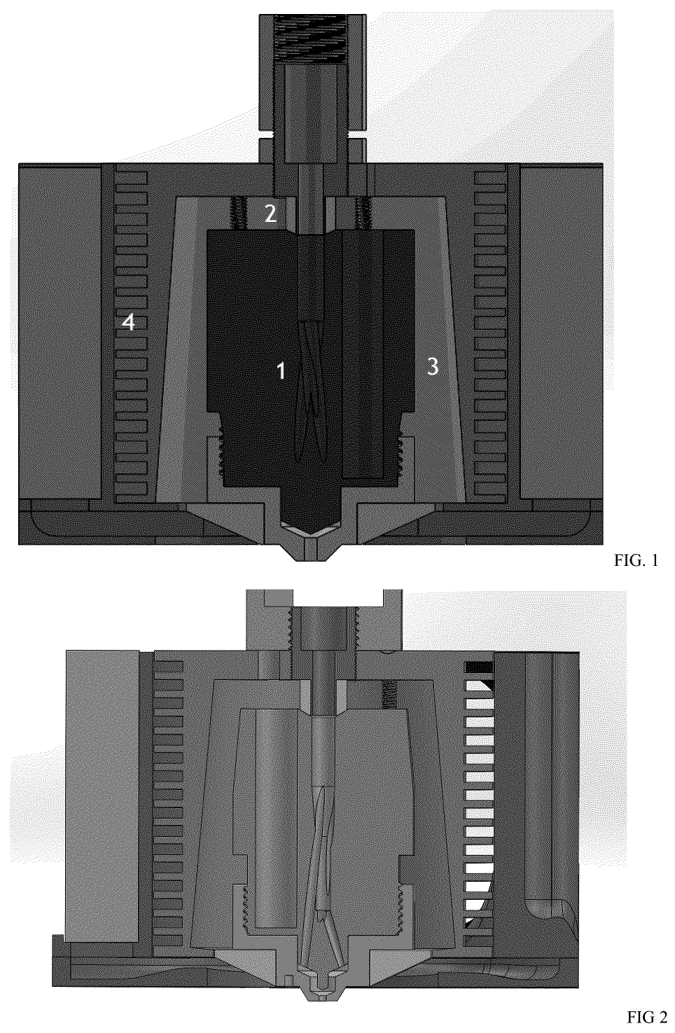

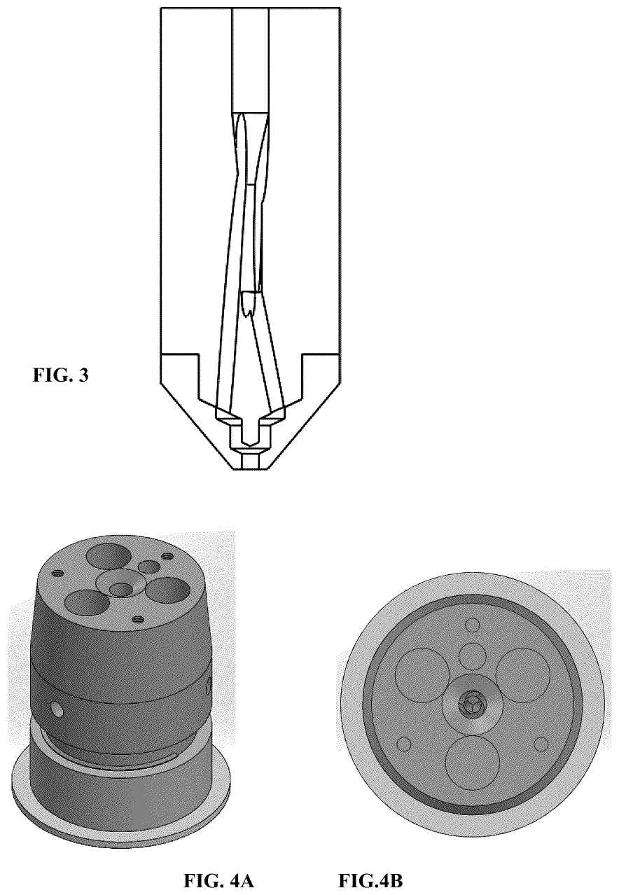

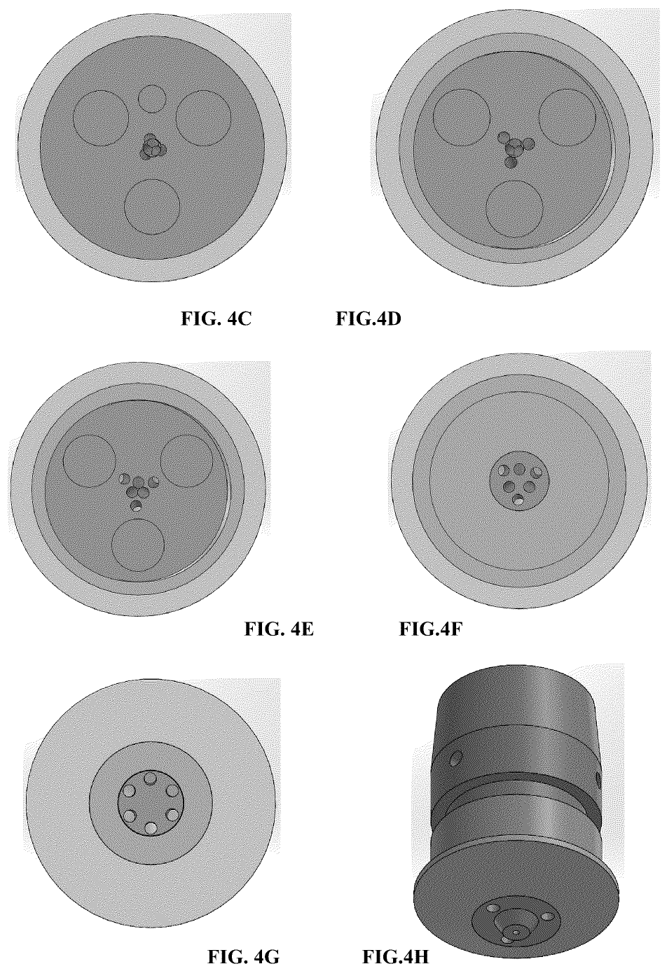

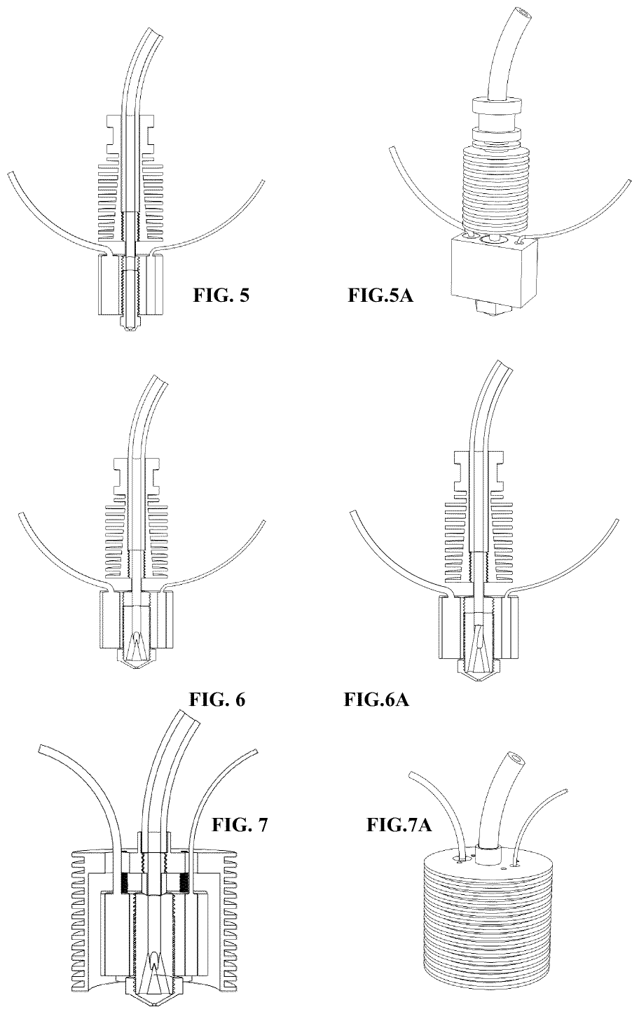

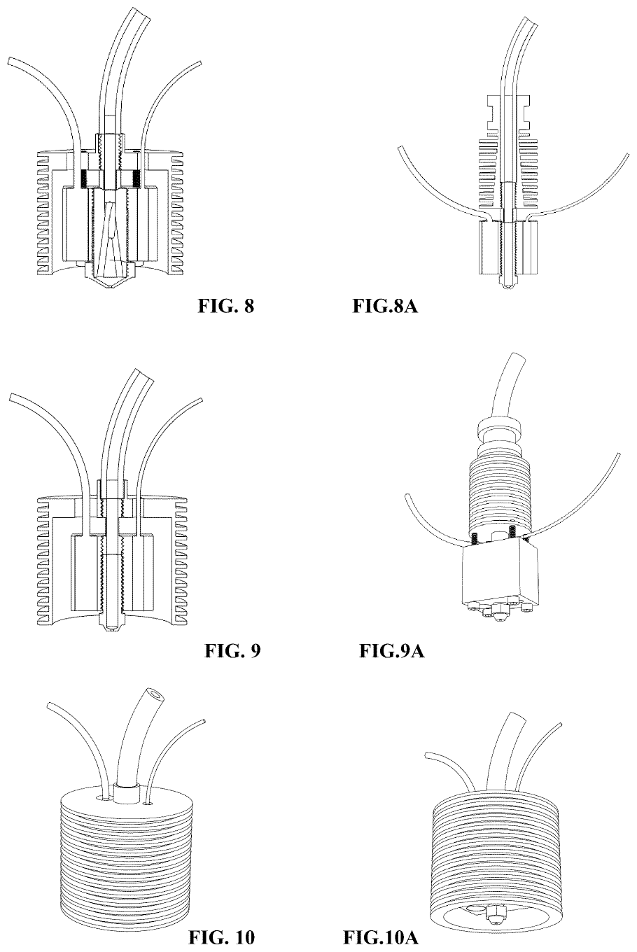

FIG. 1 and further disclose a method of operating a 3D printer of a 3D printing based manufacturing system in which a filament of printing material is driven into a printer head, in which the filament is driven into a printer head so as to be expelled therefrom in molten form, the method comprising the steps of driving the filament into a heater block thermally separated from a feeder element by means of a connection between feeder element and heating block centrally comprising a thermally isolating separator or distance member through which the filament is fed. By including a thermally not or minimally conducting distance holder in the feeding or entry path of the filament, the invention realizes that the heat path to which the filament is subjected is effectively elongated, i.e. the filament is instantly brought into contact with a heater block part of a maximum possible temperature level. Hence this measure increases the melting capacity of the heater block, and therewith improves both quality and speed of the print head.

Yet a further, in fact also independently applicable measure according to the present invention holds the receiving and heating of the filament in a first receiving section included as a common chamber for receiving filament and filament material, and subsequently dividing the filament material within a second, further filament receiving section of the heater block into separate streams of material. With such a method of 3D printing and with a 3D printer adapted thereto, high heating temperature may be attained as well as a controlled transition from solid filament stage to a gradually melting at least due to increased temperature environment, softening of the filament. This softened filament may be pressured further into separate channels where the material may be heated through and through since the thickness of the material relative to the surrounding heat wall is much more favorable than in in the first section. This is unlike many prior art designs where the core of the filament may still be unmolten or partially molten, at least not as fluid as in the circumferential parts of the filament to be spelled out.

An optimizing feature in accordance with the preceding holds that the inner wall of the first receiving section is provided with grooves spiraling towards the lower end of the section. In this manner the partly heated filament may already mechanically be somewhat mixed or split up, especially if more than one grooves is carved or otherwise at least largely shaped. An even further improvement in pre-mixing and flow of heated if not largely molten plastic is attained if the grooves each spiral towards an opening in the second receiving section for realizing said separate streams.

According to yet a further and in fact also independently applicable method step, the heated material is expelled from the heater block via a printer nozzle, receiving said separate streams and recombining the same for at least in part, the nozzle thereby maintained in intimate thermal contact with said heater block. In this manner it is assured that final mixing is with certainty performed on thoroughly softened if not molten material, since all expelled from a relatively small diameter heater channel, and since the nozzle itself in fact is virtually integrated with the heat block due to its large, circumferential and screwed thermal contact with the block. In that manner it is assured that the thoroughly heated material will not solidify at arriving in contact with a nozzle which in prior art design may be found to be of relatively lower temperature, e.g. due to the nozzle normally be screwed to an inner thread of the heater block. The nozzle according to the invention is hence provided for adhering to the heater block via screw thread provided to the outer side, i.e. circumference of an end part of the heater block. In this manner the thermal contacting surface may, with the thread even further be increased. Yet another measure to the nozzle, in fact to even further support the latter heat effect, holds that tightening of the nozzle to the heater block causes an end face of the heater block to intimately contact an at least largely corresponding, opposing face provided within the nozzle, therewith further increasing the thermal contact between heater block and nozzle. Where the latter is made of a messing type of material, internal transfer of heat is optimized.

It is remarked that in a further development of the method in accordance with the invention, the thermally separated connection between feeder element and heating block comprises radially outward disposed screws, firmly connecting the feeder element to the heater block, of course under maintaining the pre-mentioned thermally decoupling mechanical distance holder. Where the latter may be made of a composite or ceramic material, the screws are of a stainless steel, may be maintained relatively small so as thereby equally minimizing heat transfer over the screws. Where any local loss of heat level could be remarked, this will in the present, new design be relatively remotely from the central section housing and heating the filament, thereby maintaining a relatively high temperature at entry of the filament, at least temperature wise favorable condition, when compared to prior art designs. So as to promote this remoteness of a potential heat bridge, the three screws are regularly distributed disposed for said firm connection, preferably the screws incorporated in a flange-like part for the feeder element. A favorable side effect of this design is that simultaneously the rigidity or bending stiffness in the connection between feeder element and heating block is optimized, if not improved relative to many prior art designs. The presently discussed feature may hence, whether or not even only for the latter advantage, or in conjunction with or solely for the thermal effect, hence also be applied either in conjunction with the preceding for further optimization, but also independently.

In yet a further development of the present invention, and also equally independently applicable measure, the heater block is included in the print head in a manner surrounded by a standing volume of air. In this manner, despite continuous movement of the print head a continuously stable thermal environment is created for the heater block, increasing it's capacity to maintain a high and constant heat level, therewith increasing controllability of the printer head and of the printing process, in particular both the speed and the quality thereof. In a most favorable embodiment, this feature is realized by having the a volume of standing air surrounding the heater block provided by way of a heat sink included in the print head circumferentially to the heater block. Another important effect of having the heat sink circumferential to the heater block rather than preceding it, is that the height of the heater block may relatively easily be increased, therewith allowing for even further improvement and control of the melting process of a filament at entry thereof into the heater block. Also for this reason alone the heat sink may be included circumferentially to the heater block.

In a further development of the latter, the surrounding heat sink is closed to it's upper distal end by an upper wall. An upper wall part of the heat sink may form a flange part to the feeding element. In such design, the feeder element favorably is centrally screwed into an upper wall part of the circumferential heat sink.

Further to the preceding it may be noted that the feeder element is favorably formed by a mainly tubular or prismatic part, abutting to the thermally isolating distance member by a distal end face. Internally, in a preferred embodiment the inner channel thereof may at some point or gradually be formed tapered. The feeder element preferably is further secured in the print head by way of a counter acting nut, screwed to the outer side of the tubular part and abutting the flange like part to which the feeder element is secured, e.g. by the part being screwed into the flange like part via an inner screw thread thereof.

In a further favorable development of the method according to the invention, the heat sink is produced in an aluminum material, keeping centrifugal forces down for as far as increased by the more remote positioning of the weight of the heat sink. Equally if not more important is that the heater block is in the present invention also produced in aluminum. It was recognized that with the preceding measure of the invention, to generally raise and equally distribute the heat within the heat block, the filament material becomes soft in a much earlier stage, therewith reducing both internal resistance, even when in fact increased to some extend by the splitting thereof into separate streams, as well as it's abrasive effect. It is for this reason recognized that the heat block may be produced in aluminum material. This is all the more so if at least part of the inner wall of anyone of the chamber sections is provided with a diamond, in particular nano-diamond coating. Maintaining a low weight in the print head supports swift and smooth manipulation and movement of the print head and therewith speed and quality as performance factors of a print head.

In yet a further development the heater block is provided in a two part form comprising of a circumferential outer block part provided with receptacles for electric heater elements, and a central inner part provided with said first and second section receiving chambers. Preferably and favorably, the central portion is screwed into the outer portion, hence may be released, i.e. taken away therefrom e.g. for replacement, the portions thereto being provided with inner and outer screw thread respectively.

In yet a further development if the method of 3D printing, in accordance with the present invention, the heater block is provided with at least one heat sensor. This measure allows for improved control of the printer characteristic, in that the temperature may be maintained relatively low if relatively slow printing speeds are desired for any particular section of a work piece, e.g. for high quality or accuracy, and relatively high where large volumes of material may be expelled, e.g. for reason that quality may locally not be of concern or be guaranteed also under such increased printing speeds. The printing method is even further improved in that the 3D printer system of the present invention is provided with a pressure sensor. This may be for directly or indirectly sensing feeding pressure of the filament. Where such a sensor could e.g. also be included in the extruder of the filament or to a motor shaft thereof, it may also be the case that a receiving chamber or receiving chamber part is provided with a pressure sensor. A major advantage of having such pressure sensor is not only in controlling delivery of a constant stream of material and at certain pressure, but also the possibility to timely control towards a so-called retraction action of the filament, in which, at jumps over the work piece, no material is meanwhile expelled as in prior art designs or leaked at such instance, so that with certainty clean work may be delivered at all times.

It hence goes without saying that the 3D printer according to the present invention is provided with a controller controlling pressure and temperature in conjunction, i.e. as a function of the local nature of the work piece to be printed, and that different parts of a work piece may be printed with different speed, volume of flow and/or temperature of delivery.

The invention is in the following alternatively describe by way of a set of clauses, indicating features of the present invention that sometimes may in principle improve a 3D printer on it's own, but which often give best results if applied with at least a number of the features included jointly in a 3D printer.

1. A method of operating a 3D printer of a 3D printing based manufacturing system in which a filament of printing material is driven into a printer head, in which the filament is driven into a printer head so as to be expelled therefrom in molten form, the method comprising the steps of driving the filament into a heater block thermally separated from a feeder element by means of a connection between feeder element and heater or heat block centrally comprising a thermally isolating separator or distance member through which the filament is fed.

2. A method of operating a 3D printer in accordance with the preceding clause, receiving and heating the filament in a first receiving section included as a common chamber for receiving filament and filament material, and subsequently dividing the filament material within a second, further filament receiving section of the heater block into separate streams of material.

3. Method in accordance with the preceding clause, in which the inner wall of the first receiving section is provided with grooves spiraling towards the lower end of the section.

4. Method in accordance with the preceding clause, in which the grooves each spiral towards an opening in the second receiving section for realizing said separate streams.

5. Method in accordance with any of the preceding clauses in which, in a further step the heated material is and expelled from the heater block via a printer nozzle, receiving said separate streams and recombining the same for at least in part, the nozzle thereby maintained in intimate thermal contact with said heater block.

6. Method in accordance with the preceding clause, in which the nozzle is provided for adhering to the heater block via screw thread provided to the outer side, i.e. circumference of an end part of the heater block.

7. Method in accordance with the preceding clause, in which tightening of the nozzle to the heater block causes an end face of the heater block to intimately contact an at least largely corresponding, opposing face provided within the nozzle.

8. Method in accordance with any of the preceding clauses, in which the thermally separated connection between feeder element and heater, alternatively denoted heat block comprises radially outward disposed screws, firmly connecting the feeder element to the heater block.

9. Method according to the preceding clause, in which three, regularly distributed screws are disposed for said firm connection, preferably the screws incorporated in a flange-like part for the feeder element.

10. Method according to any of the preceding clauses, in which the heater block is included in the print head in a manner surrounded by a standing volume of air.

11. Method according to any of the preceding clauses, in which a volume of standing air surrounding the heater block is provided by way of a heat sink included in the print head circumferentially to the heater block.

12. Method according to any of the preceding clauses in which an upper wall part of the heat sink forms a flange part to the feeding element.

13. Method according to any of the preceding clauses in which the feeder element is centrally screwed into an upper wall part of the circumferential heat sink.

14. Method according to the preceding clause in which the feeder element is formed by a mainly tubular or prismatic part, abutting to the thermally isolating distance member by a distal end face.

15. Method according to any of the preceding clauses, in which the feeder element is further secured in the print head by way of a counter acting nut screwed to the outer side of the tubular part and abutting the flange like part to which the feeder element is secured, e.g. by the part being screwed into the flange like part via an inner screw thread thereof.

16. Method according to any of the preceding clauses in which the heat sink is produced in an aluminum material.

17. Method according to any of the preceding clauses, in which the heater block is produced in aluminum.

18. Method according to the preceding clause, in which the at least part of the inner wall of anyone of the chamber sections is provided with a diamond, in particular nano-diamond coating.

19. Method according to any of the preceding clauses, in which the heater block is provided in a two part form comprising of a circumferential outer block part provided with receptacles for electric heater elements, and a central inner part provided with said first and second section receiving chambers.

20. Method according to the preceding clause, in which the central portion is screwed into the outer portion, the portions thereto being provided with inner and outer screw thread respectively.

21. Method in accordance with anyone of the preceding clauses, in which the heater block is provided with at least one heat sensor.

22. Method in accordance with anyone of the preceding clauses, in which the 3D printer system is provided with a pressure sensor for directly or indirectly sensing feeding pressure of the filament.

23. Method in accordance with any of the preceding clauses in which a receiving chamber or receiving chamber part is provided with a pressure sensor.

24. Printer head specified with any one or more of the methods steps and print head elements as specified in anyone of the preceding clauses.

25. Printer according to the preceding invention provided with a controller controlling pressure and temperature in conjunction, i.e. as a function of the local nature of the work piece to be printed.

26. Printer according to any of the preceding printer clauses, in which different parts of a work piece may be printed with different speed, volume of flow and/or temperature of delivery.

1. 3D printer, in particular for a 3D printing based manufacturing system in which a filament of printing material is driven into a printer head, so as to be expelled therefrom in molten form, the printer head comprising a heat block provided with a filament receiving chamber into which the filament is to be driven and in which the filament, during passage through the chamber towards an end, such as a distal end of the heat block for delivery of filament material, is to be transformed into a molten, at least weakened, preferably plastically deformable state, the receiving chamber comprising of one or more sections subsequently included, characterized in that at least one section of the receiving chamber is provided with grooves, the grooves being included at an angle with the axis of the chamber, in which the receiving chamber merges into a final section of the heat block, provided with multiple channels, connecting the receiving chamber with the end of the heat block, the channels formed by straight bores, included radially diverging, and
in a plane transverse to that determined by the radial diverging, included under an angle with the axis of the receiving chamber, and in which a groove is formed by an end section of a bore.

2. Printer in accordance with claim 1, in which the grooves are provided in a second section of the chamber as taken in the direction of filament entry towards exit of weakened filament.

3. Printer in accordance with claim 1, in which the receiving chamber, taken in cross section, at least largely corresponds in dimension and shape with the cross section of the filament to be received.

4. Printer in accordance with claim 3, in which a first section of the chamber closely surrounds the filament received, typically forming a closely surrounding cylindrical section.

11. Printer in accordance with claim 1, in which the bores end distributed around a central core of the heat block.

12. Printer in accordance with claim 11, in which the central core is of a cross section larger in size than that of a bore.

13. Printer in accordance with claim 11, in which the bore ends as taken in end view, are provided at least substantially equally distributed in a regular shape, in particular within a circular shape, concentrically positioned relative to the axis of the chamber.

14. Printer in accordance with claim 1, in which the heat block is provided with a nozzle, the nozzle provided with a receiving chamber for receiving the material expelled by the heat block and guiding the same to a central discharge opening of the nozzle.

15. Printer in accordance with claim 1, in which the receiving chamber of the nozzle is provided with a generally conical shape pointing away from the heat block end, in particular in which the distal end of the heat block is centrally provided with a tip projecting into said generally conical shape.

16. Printer in accordance with claim 1, in which the heat block is provided with and heated by cylindrically shaped heat elements, included in parallel with the chamber axis and extending over the largest part of the axial length of the heat block.

17. Printer in accordance with claim 16, in which a heating element extends over at least substantially the entire axial length of the receiving chamber.

18. Printer in accordance with claim 1, in which the heat block comprises at least three of the coaxially included heat element, regularly distributed around the receiving chamber.

19. Printer in accordance with claim 1, in which the nozzle is provided for adhering to the heater block, e.g. via screw thread provided to the outer side, i.e. circumference of an end part of the heat block, the screw thread part therein surrounding an end part of the heater elements.

20. Printer in accordance with claim 1, in which the nozzle is provided with an end face for contacting a distal end of the heat block, the heat elements of the heat block being provided to extend virtually up to the end face.
